(19) United States
(12) Patent Application Publication
(10) Pub. No.: US 2005/0279688 A1
(43) Pub. Date: Dec. 22, 2005

(54) Super oxygenated electrolised ion water generation system

(76) Inventor: Maxwell Hsu, Chung-Li (TW)

Correspondence Address: Yi-Wen Tseng, 4331 Stevens Battle Lane, Fairfax, VA, 22033, US

(21) Appl. No.: 10/871,564

(22) Filed: Jun. 21, 2004

(51) Int. Cl. C02F 1/78

(52) U.S. Cl. 210/192

(57) ABSTRACT

A super oxygenated electrolised ion water generation system is capable of converting source water provided by a public water system into potable super oxygenated electrolised ion water, which includes a first filter, a second filter, a water tank, an ozone generator, a gas-water mixer, a deoxygenator and a switch. The first filter eliminates the residual chlorine, heavy metal elements, and bacteria from the preliminary clean water, and thereby produces clean water. The second filter eliminates the anions and cations from the clean water, and thereby produces pure water. The pure water is transported to and stored in the water tank. When the system proceeds the pure water generation, the ozone generator receives the pure water from the water tank and produces a mixture of ozone, oxygen and water and outputs the mixture to the pure water tank. When the switch is engaged, the clean water is conveyed to the gas-water mixer. The ozone gas flows to the gas-water mixer via a gas pipeline. The gas-water mixer mixes the clean water and the ozone gas, output super oxygenated electrolised ozonated water to the deoxygenator, and thereby produce potable super oxygenated electrolised ion water.

### BACKGROUND OF THE INVENTION

The present invention relates in general to a super oxygenated electrolised ion water generation system, and more particularly, to a super oxygenated electrolised ion water generation system capable of converting output clean water from an external filter into potable super oxygenated electrolised ion water.

The human body benefits materially from clean water. But the water from a public water system is of low quality since the water becomes contaminated while on its way to homes for consumption. The water becomes contaminated because it is conveyed to the homes through old and deteriorated plumbing. Today people are more concerned with the quality of their water because of their higher standard of living. Moreover, the health effect of using water from public water systems to rinse food, among other things, has also become a concern for many people. These concerns are justified because the processing of source water from a public water system consists of nothing more than a series of sequenced filtrations to remove debris from the water, with the addition of chlorine to sanitize the water. However, after the processed water from a public water system has arrived at a consumer's home, it has again become impure. In an effort to clean the water again, many consumers boil the water they receive. But boiling does little to actually improve the quality of the water received from the public water system. Therefore, the quality of the water people drink remains terrible from the time they receive it in their homes.

Ozone has shown itself to be an extremely useful tool in improving the quality of the drinking water that people consume such that has been gradually accepted by most consumers today as a much better method of killing bacteria than the conventional method of adding chlorine to water. Ozone has three Oxygen atoms and is rather unstable. Because Ozone is unstable it is easy for Ozone to oxidize other elements. By utilizing this oxidation Ozone can kill bacteria immediately, dissolve pesticides, remove foul odors, and disinfect. While Ozone can have a bad odor and impair a consumer's health if its density in the air exceeds the standard, edible class electrolyzed ozonated water has no such qualities. This ozonated water has no bacteria, no color, no odor, the same sanitizing and bacteria killing effect as ozone, and a highly reactive oxidation ability. Ozonated water can even dissolve blood sugar which reduces the blood sugar level, and strengthen the immune system.

Super oxygen has also been shown to be beneficial to the human body. According to many related health reports, super oxygen can activate human cells. This activation has the dual effect of promoting a higher metabolism in the human body and slowing down the aging process. Super oxygen also produces the same positive activating effect on brain cells. It is possible, therefore, that this activation effect on brain cells could help reduce the occurrences of Alzheimer's disease, and other related brain diseases. People today are more interested than ever in pursuing the use of super oxygen specifically because of these aforementioned benefits. However, water with high oxygen content cannot be produced by a common reverse osmosis filter or other water generator or filter. Water with high oxygen content is created through a complicated process. This process includes the source water being passed through three prefilters, an ion exchange resin filter, an activated carbon filter, and a reverse osmosis membrane. The water must also pass through an acid neutralizer, a magnet & magnetic stone, four ceramic filters, and bacteria killing ozone in order for the potable water to acquire high oxygen content. It is because the equipment required for this process is so complicated that the cost to generate water with high oxygen content is so high.

### BRIEF SUMMARY OF THE INVENTION

The present invention provides a super oxygenated electrolised ion water generation system including a pre-generation unit to output pure water, an ozone generator to produce ozone gas by using the pure water, and a post-generation unit to generate potable super oxygenated electrolised ion water by deoxygenating mixture of clean water from the pre-generation unit with the ozone gas.

The pre-generation unit of the super oxygenated electrolised ion water generation system provided by the present invention includes a first filter and a second filter. The first filter utilizing electrochemical oxidation-reduction reaction eliminates the residual chlorine, heavy metal elements, and bacteria from the preliminary clean water. The second filter utilizing ion exchange resin eliminates the anions and cations from the clean water and thereby produce deionized pure water. The pure water is further transported to and stored in a water tank. When the system proceeds the pure water generation, the ozone generator receives the pure water from the water tank and produces a mixture of ozone, oxygen and water and outputs the mixture to the pure water tank via a pipeline.

The post-generation unit of the super oxygenated electrolised ion water generation system provided by the present invention includes a gas-water mixer, a deoxygenator and a switch. When the switch is engaged, the clean water generated by the first filter will be conveyed to the gas-water mixer. The ozone gas stored in the pure water tank flows to the gas-water mixer via a gas pipeline. The gas-water mixer mixes the clean water and the ozone gas to output super oxygenated electrolised ozonated water. Finally, the super oxygenated electrolised ozonated water is directed to the deoxygenator, and thereby produces potable oxygenated electrolised ion water.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

These as well as other features of the present invention will become more apparent upon reference to the drawings therein:

FIG. 1 is a system diagram of a super oxygenated electrolised ion water generation system in accordance with one embodiment of the present invention;

FIG. 2 is a system diagram of a super oxygenated electrolised ion water generation system in accordance with another embodiment of the present invention;

FIG. 3 is a schematic flow diagram of a super oxygenated electrolised ion water generation system illustrating the pre-procedures of the generation of pure water;

FIG. 4 is a schematic flow diagram of a super oxygenated electrolised ion water generation system illustrating the post-procedures of the generation of super oxygenated electrolised ion water;

FIG. 5 is a perspective view of a super oxygenated electrolised ion water generation system fully assembled;

### DETAILED DESCRIPTION OF THE INVENTION

Reference will now be made in detail to the preferred embodiments of the present invention, examples of which are illustrated in the accompanying drawings. Wherever possible, the same reference numbers are used in the drawings and the description to refer to the same or like parts.

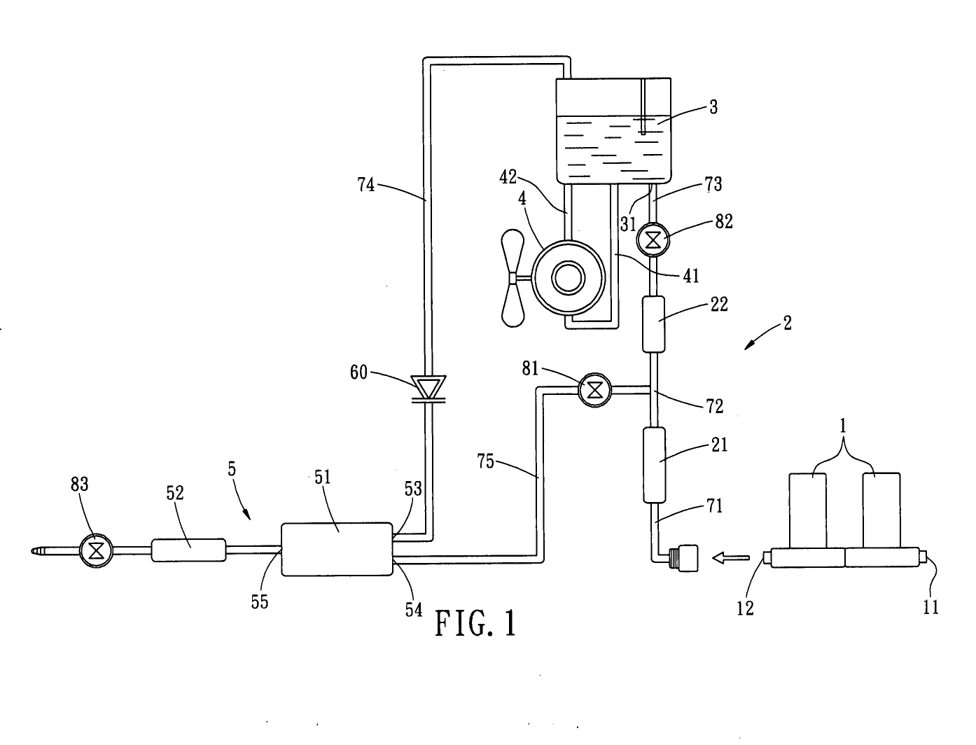

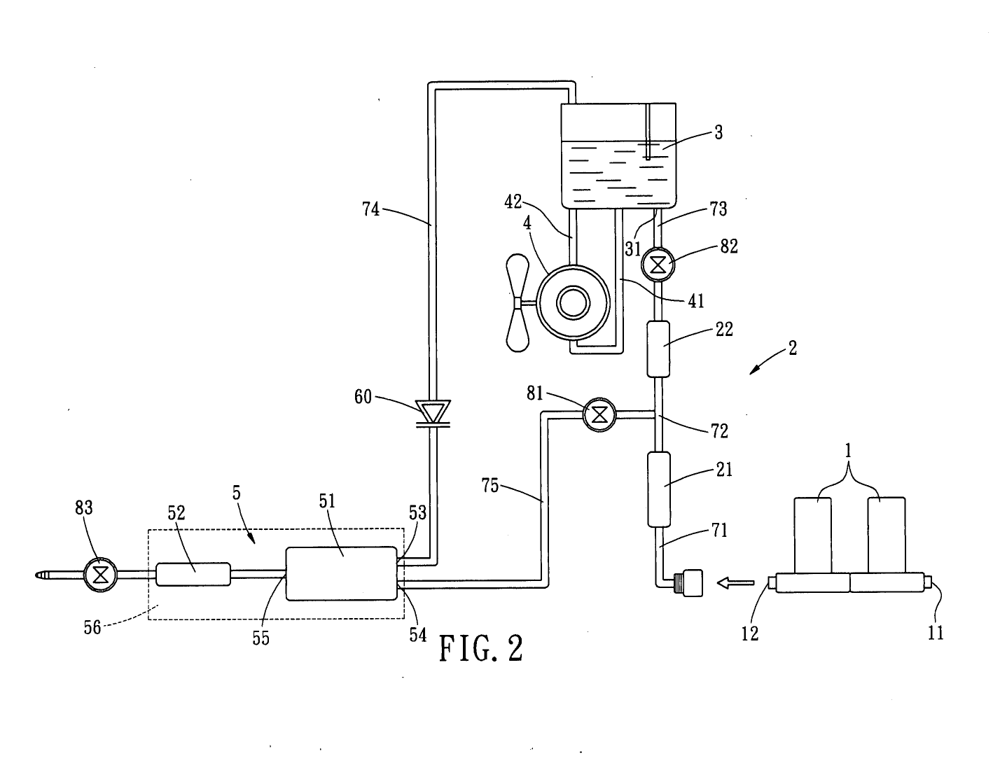

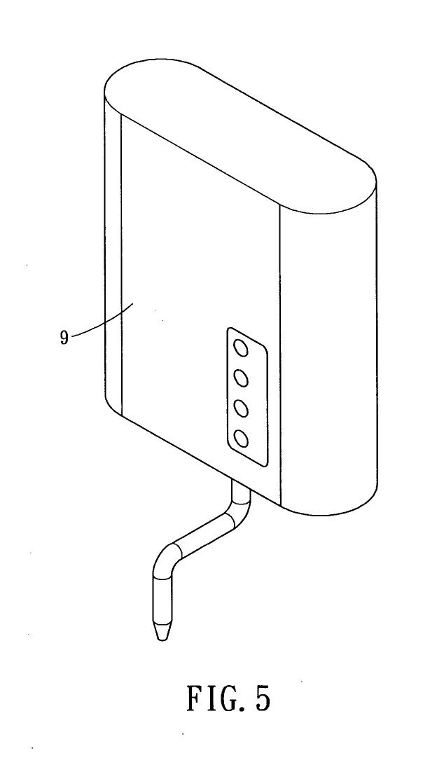

Referring to FIGS. 1 and 2, a super oxygenated electrolised ion water generation system of the present invention includes a pre-generation unit 2 to output pure water, a water tank 3 to store the pure water, an ozone generator 4 to produce ozone gas by using the pure water in the water tank 3, and a post-generation unit 5 to generate potable super oxygenated electrolised ion water by deoxygenating mixture of clean water from the pre-generation unit with the ozone gas. Moreover, before entering the super oxygenated electrolised ion water generation system, the source water has to be filtered by an external filter 1. All the components of the present invention except the external filter 1 are enclosed in a shell 9, as illustrated in FIG. 5.

The external filter 1 connects to the external hoses through a water inlet 11 in order to receive the source water, such as tap water generated from the public water system. The external filter 1 can effectively eliminate planktons, bacteria, chlorides and other large molecule impurities from the source water. A water outlet 12 of the external filter 1 is connected to a pipeline 71 so that the clean water generated by the external filter 1 can be transported to the super oxygenated electrolised ion water generation system.

The pre-generation unit 2 of the super oxygenated electrolised ion water generation system provided by the present invention further includes a first filter 21 and a second filter 22. The first filter 21 contains a filter cartridge containing copper ions, zinc ions, and activated carbon ions. The main function of the first filter 21 is to further eliminate the residual chlorine, heavy metal elements, and bacteria from the entering clean water which arrived from the external filter 1. The second filter 22 connects to the first filter 21 via a pipeline 72. The second filter 22 can eliminate the anions and cations of the clean water in order to obtain a high purity deionized water called pure water.

The water tank 3 stores the pure water generated by the second filter 22 and the ozone gas generated by the ozone generator 4. The water tank 4 connects to the second filter 22 via a pipeline 73. A second switch 82, such as a solenoid valve is installed in the pipeline 73 to control the conveying of the pure water generated by the second filter 22. The second switch 82 is further controlled by a third switch 83, such as a solenoid valve.

The ozone generator 4 has an electrolytic cell which can splits water into its basic elements and then convert part of the liberated oxygen into ozone. The ozone generator 4 receives the pure water via the pipeline 41. The ozone generator 4 outputs the mixture of ozone, oxygen and water to the pure water tank 4 via a pipeline 42.

The post-generation unit 5 of the super oxygenated electrolised ion water generation system provided by the present invention further includes a gas-water mixer 51 and a deoxygenator 52. The ozone gas stored in the water tank 3 can flow to the gas-water mixer 51 via the pipeline 74. The gas-water mixer 51 mixes the clean water from the first filter 21 with the ozone gas to produce the super oxygenated electrolised ion water. The water inlet 54 of the gas-water mixer 51 connects to the pipeline 72 via a pipeline 75, in which a first switch 81 is installed, to receive the clean water generated by the first filter 21. The gas inlet 53 of the gas-water mixer 51 connects to the water tank 3 via the pipeline 74, in which a check valve 60 is installed, to acquire the ozone gas. The gas-water mixer 51 outputs the super oxygenated electrolised ozonated water via a water outlet 55 to the deoxygenator 52. By utilizing an activated carbon filter cartridge containing sliver and a bio-ceramic filter of the deoxygenator 52, the super oxygenated electrolised ozonated water is deoxygenated to output super oxygenated electrolised ion water under the control of the third switch 83.

In the present invention, the gas-water mixer 51 and the deoxygenator 52 can be separately installed as shown in FIG. 1, or combined as a unit 56 as shown in FIG. 2.

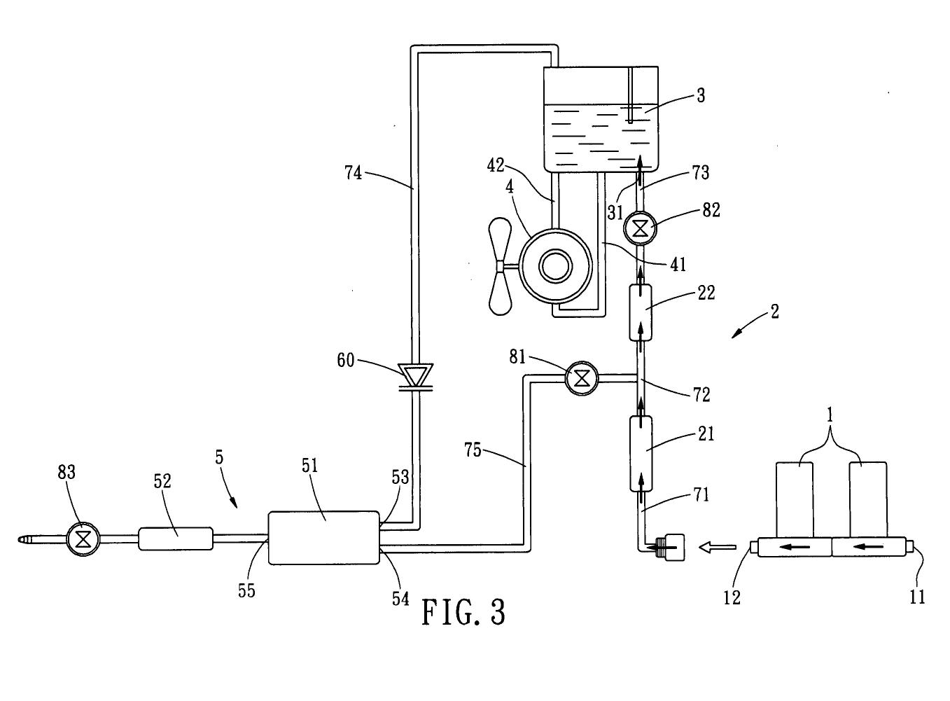

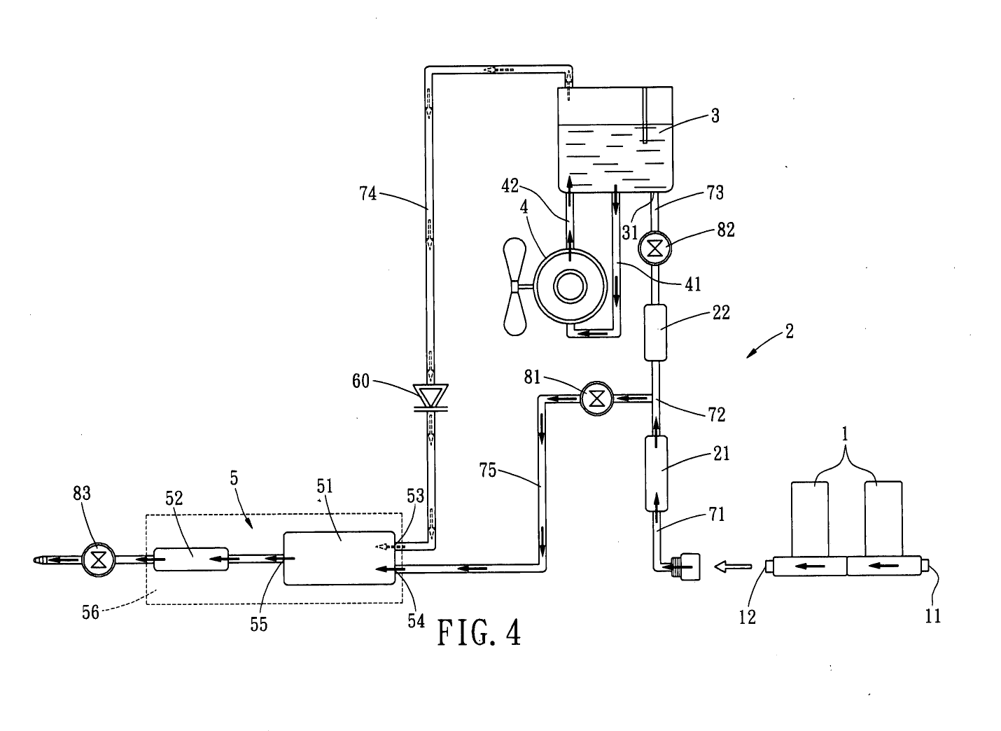

The actual operations of the super oxygenated electrolised ion water generation system are illustrated in FIGS. 3 and 4. Before entering the super oxygenated electrolised ion water generation system, the source water has to be filtered by the external filter 1. The external filter 1 can effectively eliminate planktons, bacteria, chlorides and other large molecule impurities from the source water. After the treatment by the exterior filter 1, the source water becomes preliminary clean water. To produce the clean water, the preliminary clean water has to be further filtered by the first filter 21. The first filter 21 utilizing electrochemical oxidation-reduction reaction eliminates the residual chlorine, heavy metal elements, and bacteria from the preliminary clean water which arrived from the external filter 1. After the treatment by the first filter 21, the preliminary clean water becomes clean water.

The clean water can be delivered to either the second filter 22 or the gas-water mixer 51. If the third switch 83 is off, the first switch 81 shuts down the pipeline 75. The clean water generated by the first filter 21 is directed to the second filter 22. The second filter 22 can eliminate the anions and cations from the clean water. The deionized water obtained is called pure water. The pure water is further transported to and stored in the water tank 3. The aforementioned treatments completes the pure water generation procedure, is as illustrated in FIG. 3. Certainly, if the pure water tank is full of pure water, the second switch 82 will be shut off so that no more pure water flows to the water tank 3.

When the system proceeds the pure water generation, the ozone generator 4 receives the pure water via the pipeline 41. The ozone generator produces a mixture of ozone, oxygen and water and outputs the mixture to the pure water tank 3 via the pipeline 42.

When the consumer needs the super oxygenated electrolised ion water, he engages the third switch 83. The engagement of the third switch 83 will open the first switch 81, and direct the clean water generated by the first filter 21 to the gas-water mixer 51. The ozone gas stored in the water tank 4 flows to the gas-water mixer 51 via the gas pipeline 74. The gas-water mixer 51 mixes the clean water and the ozone gas, and outputs the super oxygenated electrolised ozonated water. Finally, the super oxygenated electrolised ozonated water is directed to the deoxygenator 52, and thereby produces potable oxygenated electrolised ion water. The aforementioned treatments completes the super oxygenated electrolised ion water generation procedure, is as illustrated in FIG. 4.

While an illustrative and presently preferred embodiment of the invention has been described in detail herein, it is to be understood that the inventive concepts may be otherwise variously embodied and employed and that the appended claims are intended to be construed to include such variations except insofar as limited by the prior art.

1. A super oxygenated electrolised ion water generation system for converting input water into potable super oxygenated electrolised ion water, comprising:
a first filter for receiving the input water to output clean water;
a second filter connected to the first filter for receiving the clean water to output pure water;
a water tank connected to the second filter for storing the pure water;
an ozone generator connected to the water tank for converting the pure water into ozone, oxygen, water mixture;
a gas-water mixer connected to the second filter and the water tank for mixing the clean water and the ozone gas, and outputing super oxygenated electrolised ozonated water; and
a deoxygenator connected to the gas-water mixer for deoxygenating the electrolised ozonated water and thereby producing the super oxygenated electrolised ion water.

2. The super oxygenated electrolised ion water generation system of claim 1, further comprising a third switch for controlling the output of the high concentration electrolised ion water.

3. The super oxygenated electrolised ion water generation system of claim 2, further comprising a first switch to be opened for delivering the clean water to the gas-water mixer when the third switch is opened.

4. The super oxygenated electrolised ion water generation system of claim 1, wherein the first filter eliminates the residual chlorine, heavy metal elements, and bacteria from the input water.

5. The super oxygenated electrolised ion water generation system of claim 1, wherein the second filter eliminates the anions and cations from the clean water.

6. The super oxygenated electrolised ion water generation system of claim 1, wherein the gas-water mixer includes a water inlet connected to a first pipeline in which a second switch is installed, for receiving the clean water from the second filter, a gas inlet connected to a second pipeline in which a check valve is installed, for receiving the ozone gas from the water tank, and a water outlet connected to the deoxygenator.

7. The super oxygenated electrolised ion water generation system of claim 1, wherein the gas-water mixer and the deoxygenator are separately installed.

8. The super oxygenated electrolised ion water generation system of claim 1, wherein the gas-water mixer and the deoxygenator are combined as a unit.

9. The super oxygenated electrolised ion water generation system of claim 1, wherein the deoxygenator includes an activated carbon filter cartridge containing sliver and a bio-ceramic filter.
